(19) United States
(12) Patent Application Publication
(10) Pub. No.: US 2022/0270022 A1
(43) Pub. Date: Aug. 25, 2022

(54) SECURITY SERVICES APPLICATION

(71) Applicant: CHARLOTTE LEWIS, ARLINGTON, TX (US)

(72) Inventor: CHARLOTTE LEWIS, ARLINGTON, TX (US)

(21) Appl. No.: 17/677,767

(22) Filed: Feb. 22, 2022

Related U.S. Application Data
(60) Provisional application No. 63/152,159, filed on Feb. 22, 2021.

(51) Int. Cl. G06Q 10/06; G06Q 10/10; G08B 25/01

(52) U.S. Cl. CPC G06Q 10/063112; G06Q 10/1053; G08B 25/016

(57) ABSTRACT

A method of hiring a security detail includes reviewing available security personnel and identifying a target entity. The method includes the use of a software program carried out via an electronic system to allow a security personnel to be hired. The hiring user may select the target entity, select the security personnel and dictate the terms of the work. Payment may be provided through the application over a network and the terms of the detail may be modified as needed in real time.

### CROSS REFERENCE TO RELATED APPLICATIONS

This application claims the benefit of an earlier filing date and right of priority to U.S. Provisional Application No. 63/152,159, filed 22 Feb. 2021, the contents of which is incorporated by reference herein in its entirety.

### BACKGROUND OF THE INVENTION

### 1. Field of the Invention

The present application relates to a software application and system, and more particularly to an application and system for providing hired security personnel and means for communicating between users and the security personnel.

### 2. Description of Related Art

With society beginning to be more turbulent and the safety of individuals needing to be ensured, there exists gaps in the needs of ordinary individuals and what the market is typically able to provide. Generally those that are wealthy have security details which include one or more professionals that follow the user around. These are visible to the public and the user. The security details are often full-time employed by the user. This is very costly and out of reach for most individuals.

Some security details are contracted out for particular events and times but this is not as common. These are usually to protect the user who hired the detail and are always visible to the public. As the security details are next to the user to be protected, communication between them is fairly simple and vocal communication is often sufficient.

Although strides have been made, shortcomings remain. Despite these possibilities with security details, needs are not met with conventional services and technology. A system or application is needed to work with the conventional public in a manner that reduces costs. Additionally, it is needed to have the system permit communication between the security detail and the one who hired them and/or also the one to be protected. This is important where the one protected is not aware of the protection, or is not in direct contact with the security detail.

### BRIEF SUMMARY OF THE INVENTION

It is an object of the present application to allow for specific one-time use of the security detail in an effort to minimize costs to users. An additional benefit is for the security personnel which can now have immediate access to additional work in a way that fits their availability. In general, pricing may be done in various ways, such as tiered pricing, or flat rate pricing. The security details may provide on demand services. These services may be scheduled in advance or may be set at time of need and the application assist in coordinating available security personnel open and able to assist. The user is able to see and review the available security personnel and select the one of his/her choice. The software application is configured to exchange information between the hiring user and the security personnel related to personal data of each and information related to the scope of services and the target of the security detail.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a flow chart of the login functions of both a user and a security personnel in a software application according to an embodiment of the present application.

FIGS. 2 and 3 are flow charts of the functions of the user with the software application of the present application.

FIG. 4 is a flow chart of the functions of the security personnel in the software application of the present application.

FIG. 5 is a diagram of an electronic system to perform the functions of the software application of FIG. 1.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments and functions of the present application are herein described. It should be noted that the articles “a”, “an”, and “the”, as used in this specification, include plural referents unless the content clearly dictates otherwise.

The software application of the present application is configured to permit the selective hiring and communication between a user and a security personnel. The application allows a security personnel to be hired based upon a specified time frame, a specified event, and for protection of the user or a third party. The application is configured to permit communication between the user, the security personnel, and optionally a remote third party. One or more verification steps and job related functions are provided through the application as will be discussed herein. These functions are not meant to be limiting or fully exhaustive but are provided to help ascertain the scope of functions permitted. Some variations may exist in broader terms.

A user is a person which wishes to hire a security detail having one or more security personnel. The detail may be hired for a specific event or for a particular time. A key feature of this application is to provide access to conventional public users of qualified or trained security personnel. The user may be hiring the detail to protect himself/herself or any third party, such as an employee or a family member for example. It is important to note that the security detail may or may not be known to the one being protected. Additionally, the security detail may or may not be permitted to engage with the one protected.

An object of the present application is to allow for specific one-time use of the security detail in an effort to minimize costs to users. An additional benefit is for the security personnel which can now have immediate access to additional work in a way that fits their availability. In general, pricing may be done in various ways, such as tiered pricing, or flat rate pricing. The security details may provide on demand services. These services may be scheduled in advance or may be set at time of need and the application assist in coordinating available security personnel open and able to assist. The user is able to see and review the available security personnel and select the one of his/her choice. The software application is configured to exchange information between the hiring user and the security personnel related to personal data of each and information related to the scope of services and the target of the security detail.

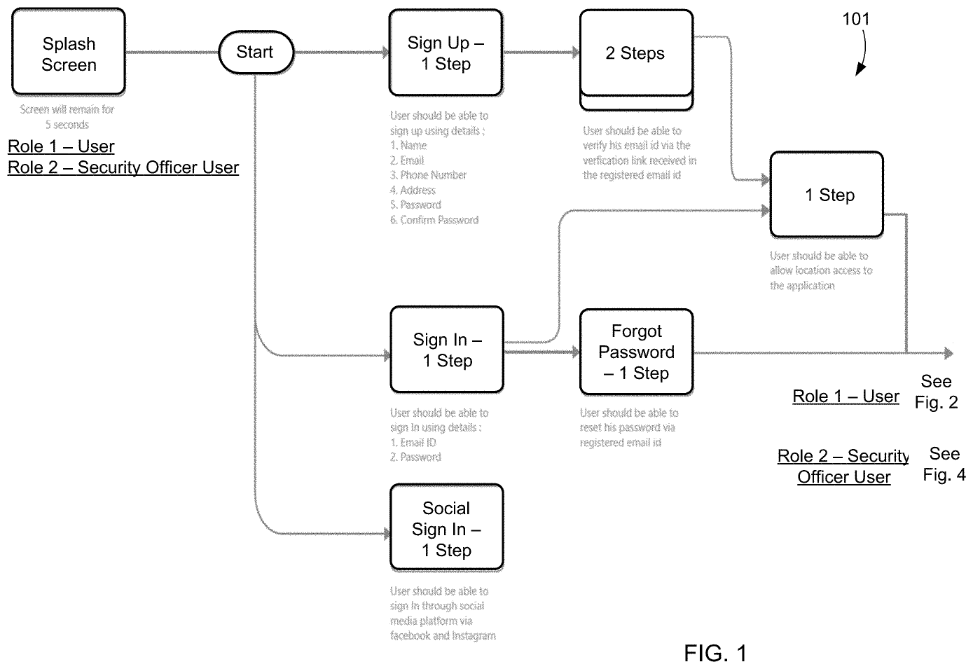

Referring now to FIG. 1 in the drawings, a flow chart of the log in information section of the software application system 101 of the present application is provided. The software application of the present application is configured to coordinate the hiring or obtaining of a security detail for the protection or monitoring of a target entity. Typically, 2 or more individuals would be involved. A security personnel is hired to monitor or protect the target entity. The target entity is protected by or monitored by the security personnel. And optionally a hiring user may be used to initiate the security detail when it is not initiated by the target entity.

Both the user (hiring user or target entity) and the security personnel have a profile. Log in information is provided based on passwords and particular unique user identifiers. Biometric verifications may be permitted, such as fingerprint, feature scans of the security personnel. The system is configured such that the user and security personnel has to create a profile which is tied to all their activity in the software application of the system. The system also provides various verification methods or stages to authenticate the user. FIG. 1 is useful to show various functions of the software application 101 to accomplish the log in functions.

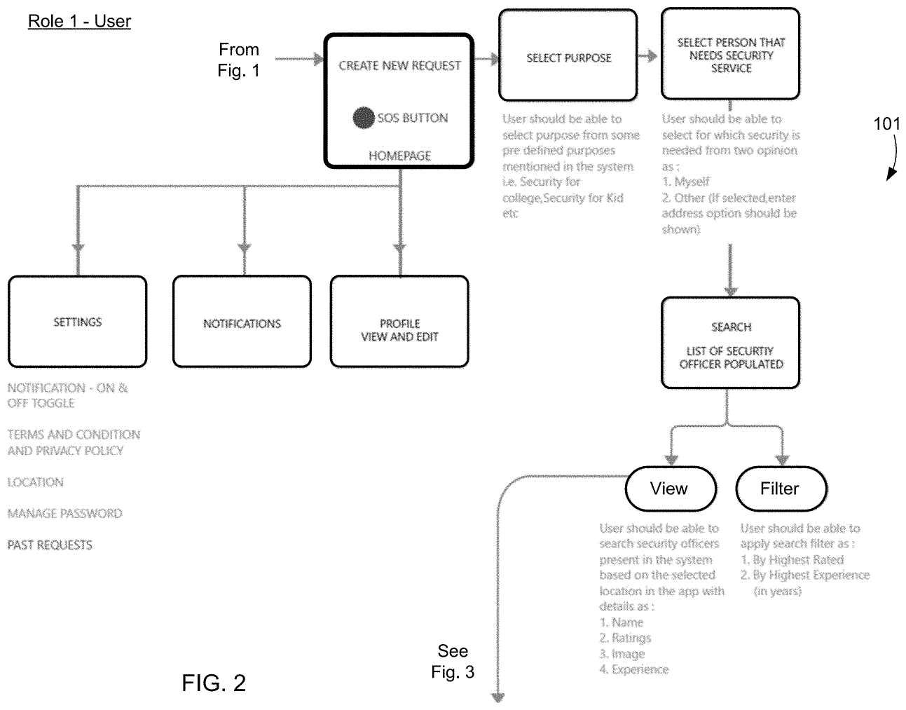

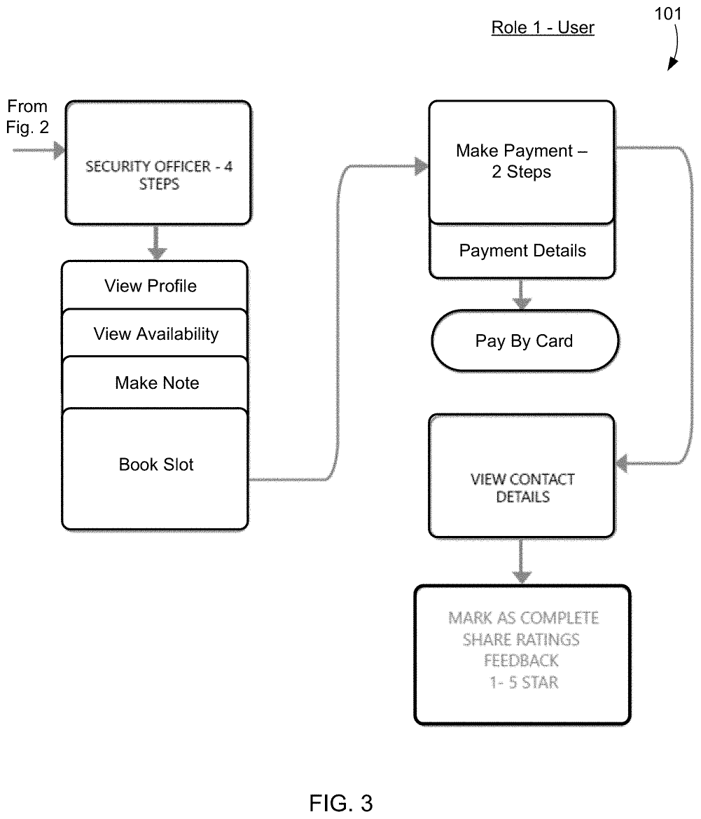

Referring now also to FIGS. 2 and 3 in the drawings, wherein the flow chart continues with respect to the functions of the hiring user (one hiring the security personnel) in the system of the present application. From the initial home screen a user may create a new request, access selected preferences or settings, or send out an immediate request for help. As seen in FIG. 2, once in the system, the user is able to view and/or adjust settings, notifications, and profile information as needed to customize system functions and performance. The request for help may be configured to broadcast a notice of emergency or distress signal to one or more individuals or entities. For example, the user selecting this function may trigger the system to send an alert or distress signal to the security personnel via the software, may trigger the system to send an alert to the user or other remote third party, and/or may trigger the system to send an alert to police, fire, security companies, or others. A user (at least any of security personnel, hiring user, or target entity) of the system may adjust whom receives the emergency notification and the type of action preferences to be performed if it is activated.

The user may create a request through the system and software for a defined purpose and provide information related thereto. The user may identify the type of detail required, including the number of persons, the person which is receiving the protection, security personnel requirements, and other information. This information is useful as it may be made available to the security personnel who are looking for work and potentially may review the request before offering their services. Additionally, security personnel may input into the system their availability and a user may be able to sort and filter through available security personnel to make a selection. Communication between the user and the security personnel at this stage is permitted through the software and system.

Referring in particular to FIG. 3 in the drawings, the user is shown able to view the profile of the security personnel, verify their availability, make notes on that user for future or current use, and optionally book a time for service. Payment may be made by the user prior to the security detail begins. The system may permit functions of an escrow account to ensure payment is paid to the security personnel only after actual services are satisfactorily performed. Payment details between users may be made or customized though the system and payment can be set as agreed by the users. After services are performed, the user may provide feedback to the security personnel and rate their services.

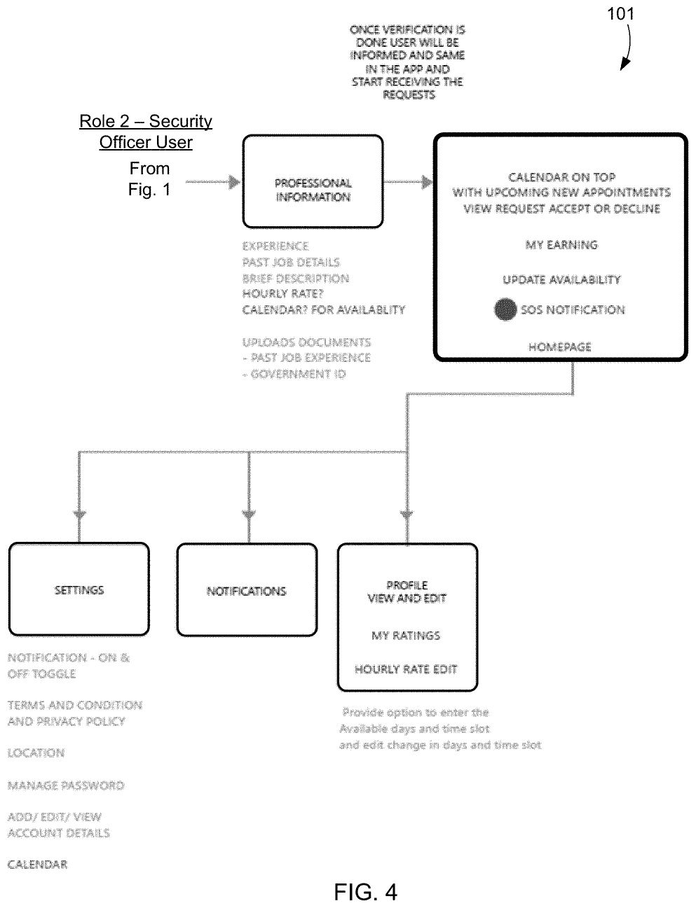

Referring now also to FIG. 4, the flow chart of FIG. 1 continues with respect to the functions of the security personnel in the system of the present application. The system provides a home screen for the security personnel which provides capabilities to the user such as uploading documents (i.e. certifications, awards, qualifications, resume, and so forth) rates, personal descriptions, job experiences, and the like. This is viewable information to prospective users. The security personnel may assign a schedule of availability, set the rates, view and accept/decline user requests.

From the initial home screen a security personnel may review/accept/decline new requests, access selected preferences or settings, or send out an immediate request for help. As seen in FIG. 2, once in the system, the user is able to view and/or adjust settings, notifications, and profile information as needed to customize system functions and performance. The requests for help may be configured to broadcast a notice of emergency to one or more individuals or entities in accordance with the same functions and features are permitted herein with respect to the security personnel as mentioned previously with the users in FIGS. 2 and 3.

It is important to note that the system is configured to permit multiple users, namely the user who is hiring the security personnel, the target entity being protected, and the security personnel which may include multiple personnel constituting a team. Where a team is used, one or more of the security personnel may be provided communication capabilities. For example, one security personnel may be selected as the point/lead and thereby be in charge of all communication. In another example, multiple security personnel may be permitted full or partial communication functions. The system may customize any communications related to the user, protected user, and other security personnel. Such permissions/restrictions are typically preset at time of the request but may be configurable in real-time as needed by any users.

The communications features and functions of the present software application and corresponding system are important for setting it apart from conventional practices. The software application is operable via one or more electronic devices having any number of input/output devices, mass storage, processors, modules, sensors, and suites to enable communication, user interaction, data capture and storage, and viewing of information. The system of the present application is configured to provide the type of communication and collaborative capability between all users that allows the system to provide access to security professionals at reasonable rates. Additionally, the communication suite permits real-time ability of the users to coordinate and adapt to real-time changes. This is ideally useful where the hiring user is not the protected user.

For example, when a parent hires a security personnel to watch their child for a specific activity, needs may arise where the activity changes. The location of the activity may change. The time duration of the activity may change. The communication suite of the system 101 permits the security personnel to communicate with the hiring user to seek clarification. Time may be extended for the security personnel. If the scope of the detail is changed then changes in rates may be agreed upon in real-time. There may arise a situation where the security personnel may ask to be replaced during the detail. This may occur and be coordinated through the system. The system is configured to process and coordinate changes in details, security personnel, rate modifications, and the like in real-time.

As noted above, the protected user may not be the hiring user. The protected user may or may not know of the protection detail. Therefore, the protected user may or may not have a user account via the system of the present application. If the protected user has a profile in the system, the protected user may receive and transmit information with the hiring user and/or the security personnel during the detail. For example, the protected user may receive an image of the security personnel and text messages.

Part of the user request for detail is deciding on the level of engagement. A user may elect to have engagement or no engagement between the security personnel and the protected user. The level of engagement can be varied. Where engagement is permitted, the security office user may be visible or not to the protected user. The security personnel may be asked to stay within a selected distance so as to be a visible deterrent to others in the public but not interfere with the happenings of the protected user. Additionally, the security personnel may be asked to stay in close proximity to the protected user. Where no engagement is asked, the protected user may or may not be notified of the security detail and the security personnel may be a distant observer only, maybe only stepping in where the safety of the protected user is at risk. The scope and level of engagement may be varied, customized, and adjusted prior to and during the security detail.

The software application 101 of the present system may be configured to provide location services of the different users. The security personnel may see the location of the protected user. The protected user may see the location of the security personnel. The hiring user may see the location of both other users. The location may be tracked continuously or on demand as requested by any user. For example, a security detail in an open area with good visibility may allow the security personnel an ability to see the protected user most of the time. Therefore the location function may not be needed. However, the security detail may be in a congested area with line of sight abilities being hindered. The location function may be necessary to assist in tracking the movements and whereabouts of the users (for both the security personnel and the protected user).

The system is also configured to permit quick safety communications between the security personnel and the protected user. Whether on the home screen in the software application or other location, these two users may be able to push a single button and send out a notification to the other. This may be a status check notification. The security personnel may send it to the protected user seeking verification of status (i.e. in congested areas with limited line of sight). The protected user may then respond with a simple push of a button. The response notification may be a simple “OK” or “Need Help” for example. The message of the response may be altered or customized.

As noted above, each user is able to transmit an emergency notification. This is easily and quickly accessible via the application. The notification may vary depending on the user's role in the detail, and it may elicit different responses or calls to action depending on the scope of the detail. Such notifications and response protocols may be determined prior to the security detail or adjusted in real-time.

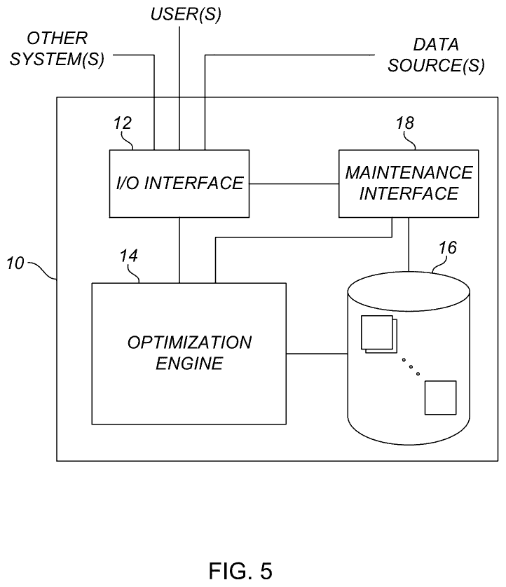

Referring now to FIG. 5 in the drawings, an electronic system 10 is illustrated that is used to carry out the functions and features of the software application. System 10 is an exemplary electronic system operable through any of the users/personnel/entities above over a network.

The system 10 includes an input/output (I/O) interface 12, a processor 14, a database 16, and a maintenance interface 18. Alternative embodiments can combine or distribute the input/output (I/O) interface 12, processor 14, database 16, and maintenance interface 18 as desired. Embodiments of the system 10 can include one or more computers that include one or more processors and memories configured for performing tasks described herein below. This can include, for example, a computer having a central processing unit (CPU) and non-volatile memory that stores software instructions for instructing the CPU to perform at least some of the tasks described herein. This can also include, for example, two or more computers that are in communication via a computer network, where one or more of the computers includes a CPU and non-volatile memory, and one or more of the computer's non-volatile memory stores software instructions for instructing any of the CPU(s) to perform any of the tasks described herein. Thus, while the exemplary embodiment is described in terms of a discrete machine, it should be appreciated that this description is non-limiting, and that the present description applies equally to numerous other arrangements involving one or more machines performing tasks distributed in any way among the one or more machines. It should also be appreciated that such machines need not be dedicated to performing tasks described herein, but instead can be multi-purpose machines, for example computer workstations, that are suitable for also performing other tasks. Furthermore, the computers may use transitory and non-transitory forms of computer-readable media. Non-transitory computer-readable media is to be interpreted to comprise all computer-readable media, with the sole exception of being a transitory, propagating signal.

The I/O interface 12 provides a communication link between external users, systems, and data sources and components of the system 10. The I/O interface 12 can be configured for allowing one or more users to input information to the system 10 via any known input device. Examples can include a keyboard, mouse, touch screen, microphone, and/or any other desired input device. The I/O interface 12 can be configured for allowing one or more users to receive information output from the system 10 via any known output device. Examples can include a display monitor, a printer, a speaker, and/or any other desired output device. The I/O interface 12 can be configured for allowing other systems to communicate with the system 10. For example, the I/O interface 12 can allow one or more remote computer(s) to access information, input information, and/or remotely instruct the system 10 to perform one or more of the tasks described herein. The I/O interface 12 can be configured for allowing communication with one or more remote data sources. For example, the I/O interface 12 can allow one or more remote data source(s) to access information, input information, and/or remotely instruct the system 10 to perform one or more of the tasks described herein.

The database 16 provides persistent data storage for system 10. While the term “database” is primarily used, a memory or other suitable data storage arrangement may provide the functionality of the database 16. In alternative embodiments, the database 16 can be integral to or separate from the system 10 and can operate on one or more computers. The database 16 preferably provides non-volatile data storage for any information suitable to support the operation of the system 10, including various types of data discussed above in connection with FIGS. 1-4.

The maintenance interface 18 is configured to allow users to maintain desired operation of the system 10. In some embodiments, the maintenance interface 18 can be configured to allow for reviewing and/or revising the data stored in the database 16 and/or performing any suitable administrative tasks commonly associated with database management. This can include, for example, updating database management software, revising security settings, and/or performing data backup operations. In some embodiments, the maintenance interface 18 can be configured to allow for maintenance of the processor 14 and/or the I/O interface 12. This can include, for example, software updates and/or administrative tasks such as security management and/or adjustment of certain tolerance settings. The processor 14 is configured for compiling and processing the data stored therein and for carrying out the functions of system 101. The processor 14 can include various combinations of one or more processors, memories, and software components.

The current application has many advantages over the prior art. The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A method of hiring a security detail, comprising:
logging into a system coupled to a network in order to view available security personnel;
reviewing one or more security personnel through the network;
selecting a target entity;
selecting a security personnel for the target entity over the network;
providing payment; and
transmitting over the network a notification to the security detail.

2. The method of claim 1, wherein details of the target entity are transmitted to the security detail.

3. The method of claim 1, further comprising:
selecting a purpose for the security detail.

4. The method of claim 3, wherein the purpose of the security detail is to monitor the target entity without contact with the target entity.

5. The method of claim 3, wherein the purpose of the security detail is to monitor and communicate with the target entity.

6. The method of claim 3, wherein the purpose of the security detail is to shadow the target entity.

7. The method of claim 1, further comprising:
sending a notification over the network between the security detail and the target entity.

8. The method of claim 7, wherein the notification is a distress signal.

9. The method of claim 8, wherein the distress signal is sent to a hiring user.

10. The method of claim 8, wherein the distress signal is sent to a third party.

11. The method of claim 8, wherein parameters for the functions of the distress signal are adjustable over the network by at least one of a hiring user, the security personnel, and the target entity.

12. The method of claim 1, further comprising:
monitoring the location of the target detail over the network via global positioning coordinates.

13. The method of claim 1, further comprising:
modifying details of the selected purpose for the security detail.

14. The method of claim 13, wherein the details are modified by the target entity.

15. The method of claim 13, wherein the details are modified by a hiring user.

16. The method of claim 13, wherein the details include duration of services.

17. The method of claim 13, wherein the details include switching the security detail.

18. The method of claim 13, wherein the details include switching the target entity.

19. The method of claim 1, wherein logging in to the system includes the use of biometric verifications.

20. A method of hiring a security detail, comprising:
logging into a system coupled to a network in order to view available security personnel;
reviewing one or more security personnel through the network;
selecting a security personnel for a target entity over the network;
providing payment; and
transmitting over the network a notification to the security detail;
wherein the target entity is a hiring user.
